(19) United States
(12) Patent Application Publication
(10) Pub. No.: US 2016/0118010 A1
(43) Pub. Date: Apr. 28, 2016

(54) Display Driving Apparatus, Source Driver and Skew Adjustment Method

(71) Applicant: Novatek Microelectronics Corp., Hsin-Chu (TW)

(72) Inventors: Chin-Hung Hsu, Taoyuan City (TW); Hsiu-Hui Yang, Hsinchu City (TW); Te-Hsien Kuo, Keelung City (TW)

(21) Appl. No.: 14/711,797

(22) Filed: May 14, 2015

(30) Foreign Application Priority Data
Oct. 24, 2014 (TW) 103136843

(51) Int. Cl. G09G 3/36

(52) U.S. Cl. CPC G09G 3/3685; G09G 2310/08

(57) ABSTRACT

A display driving apparatus includes a timing controller, for generating and outputting a first clock signal and a first data signal; and a plurality of source drivers, each source driver receiving the first clock signal and the first data signal, wherein there is a respective first skew value between the received first clock signal and the received first data signal for each source driver; wherein each source driver adjusts the respective first skew value to a respective second skew value.

### BACKGROUND OF THE INVENTION

1. Field of the Invention

The present invention relates to a display driving apparatus, a source driver and a skew adjustment method, and more particularly, to a display driving apparatus, a source driver and a skew adjustment method capable of adjusting the skew value for accurately receiving data.

2. Description of the Prior Art

With rapid development of display technology, traditional cathode ray tube (CRT) displays have been gradually replaced by liquid crystal displays (LCDs). A panel driving apparatus of an LCD usually includes a timing controller, source drivers, gate drivers and signal lines (such as clock signal lines, data signal lines and control signal lines) for transmitting various signals. LCD devices now have higher resolutions, and as a result data throughput between the timing controller and the source drivers has greatly increased. Various high speed transmission technologies have been applied for data transmission. Moreover, as the requirements for larger screen sizes increase, the trace design becomes more complex and quality of the signal transmission will be affected by transmission environment factors accordingly.

Please refer to FIG. 1, which is a schematic diagram of a conventional display driving apparatus 10. The display driving apparatus 10 includes a timing controller 102 and source drivers X1-X3. As shown in FIG. 1, the timing controller 102 is connected to the source drivers X1-X3 in a multi-drop architecture. The timing controller 102 simultaneously transmits a same clock signal and data signal to each connected source driver. However, the arrival time of the clock signal and the data signal of the source drivers may be different due to various reasons, such as asymmetrical lengths or loadings of the transmission lines, discontinuous impedances of the transmission lines. In such a situation, when the timing controller transmits the clock signal and the data signal to the connected source drivers via transmission interfaces, there exists leading or lagging relations between the clock signal and the data signals for each source driver. In other words, there exists a signal skew value between the received clock signal and the received data signals for each source driver.

Moreover, since there are different signal traces, transmission distances and transmission paths between the timing controller 102 and each source driver, each source driver has a different signal skew value between the received clock signal and the received data signal. As shown in FIG. 1, in an ideal condition, all source drivers should have the same signal skew value between the received clock signal and the received data signal. Actually, a skew value skew1 exists between the clock signal and the data signal received by the source driver X1, a skew value skew2 exists between the clock signal and the data signal received by the source driver X2 and a skew value skew3 exists between the clock signal and the data signal received by the source driver X3. In other words, different source drivers correspond to different skew values.

However, in the conventional display driving apparatus, the timing controller usually provides a fixed common default skew value for all connected source drivers on a link port for data reception. However, the fixed common default skew value may not be appropriate for all connected source drivers. For example, as the actual signal skew is too large, the system has insufficient setup/hold time margins, thus causing data access failures of the source driver and resulting in display errors. Thus, the prior art has to be improved.

### SUMMARY OF THE INVENTION

It is therefore an objective of the present invention to provide a display driving apparatus, a source driver and a skew adjustment method capable of adjusting the skew value for accurately receiving data

The present invention discloses a display driving apparatus, comprising: a timing controller, for generating and outputting a first clock signal and a first data signal; and a plurality of source drivers, each source driver receiving the first clock signal and the first data signal, wherein there is a respective first skew value between the received first clock signal and the received first data signal for each source driver; wherein each source driver adjusts the respective first skew value to a respective second skew value.

The present invention further discloses a source driver, comprising: a receiving unit, for receiving a first clock signal and a first data signal, wherein there is a first skew value between the first clock signal and the first data signal; a skew obtaining device, for obtaining a second skew value; and a skew adjustment unit, coupled to the skew obtaining device, for delaying at least one of the received first clock signal and the received first data signal to generate a second clock signal and a second data signal according to the second skew value, wherein there is the second skew value between the second clock signal and the second data signal.

The present invention further discloses a skew adjustment method for a source driver, comprising: receiving the first clock signal and the first data signal, wherein there is a first skew value between the first clock signal and the first data signal; obtaining a second skew value; and adjusting at least one of the first clock signal and the first data signal to generate an adjusted second clock signal and an adjusted second data signal, so that there is the second skew value between the adjusted second clock signal and the adjusted second data signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional display driving apparatus.

FIG. 2 is a schematic diagram of a display driving apparatus according to an embodiment of the present invention.

FIG. 3 is a schematic diagram of the source driver shown in FIG. 2.

FIGS. 4-6 are schematic diagrams of alternative embodiments of the source driver shown in FIG. 3, respectively.

FIG. 7 is a schematic diagram of an alternative embodiment of the display driving apparatus shown in FIG. 2.

FIGS. 8-11 are timing diagrams of the source driver shown in FIG. 6, respectively.

FIG. 12 is a schematic diagram of an alternative embodiment of the source driver shown in FIG. 3.

FIG. 13 is a schematic diagram of an alternative embodiment of the skew obtaining device shown in FIG. 12.

FIGS. 14-15 are schematic diagrams of the automatic skew scanning according to alternative embodiments of the present invention.

FIGS. 16-18 are timing diagrams of the source driver shown in FIG. 12, respectively.

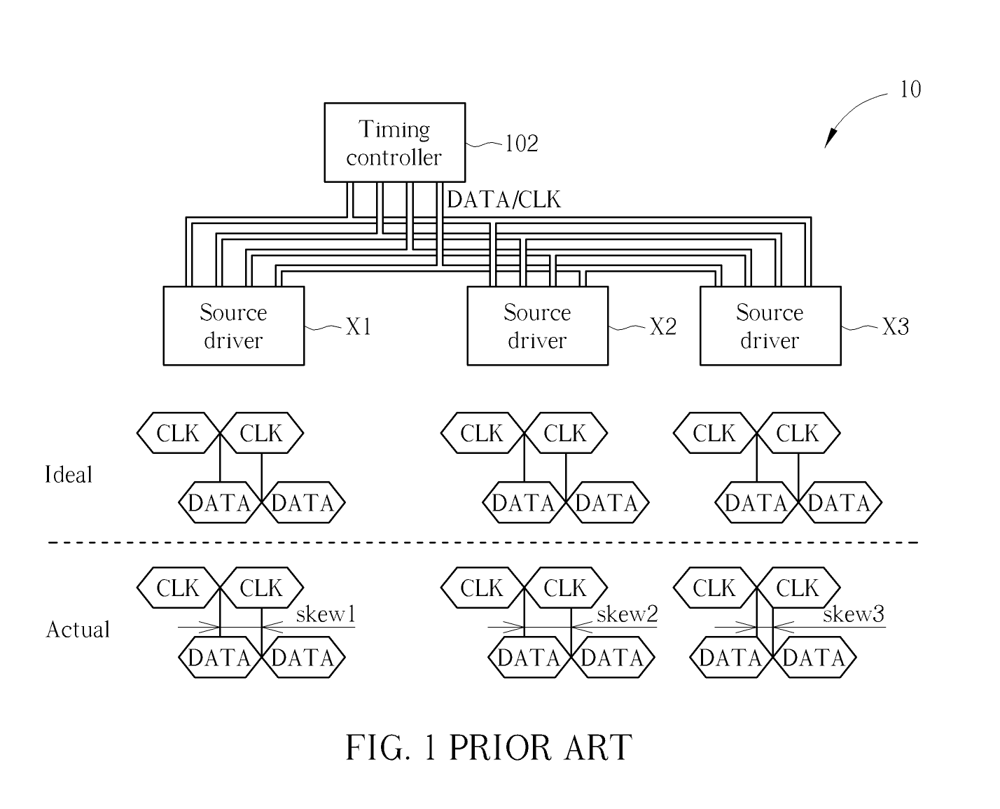

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and the claims as well, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

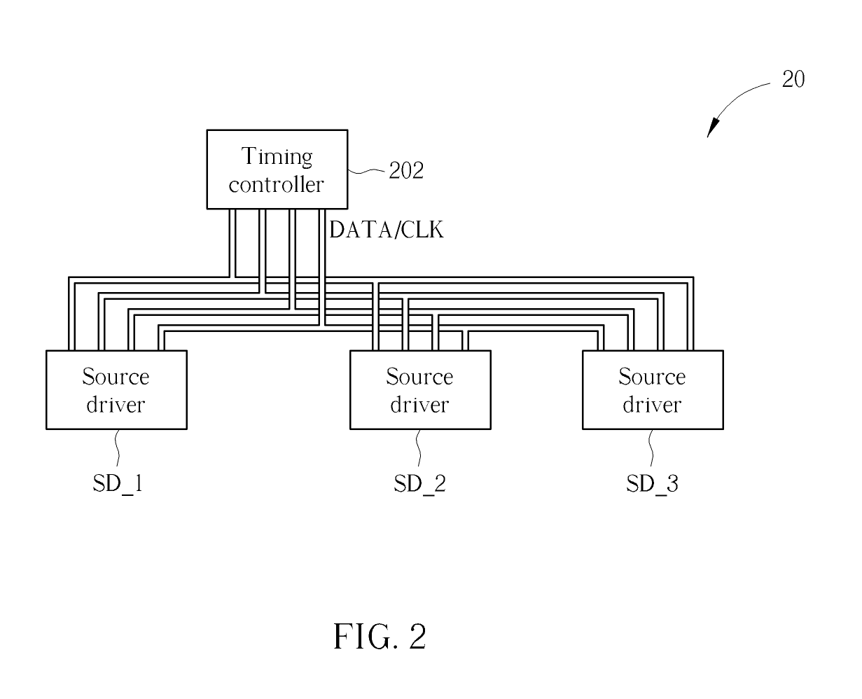

Please refer to FIG. 2, which is a schematic diagram of a display driving apparatus 20 according to an embodiment of the present invention. The display driving apparatus 20 includes a timing controller 202 and source drivers SD_1-SD_3. As shown in FIG. 2, the timing controller 202 generates and outputs a clock signal CLK and a data signal DATA to the source drivers SD_1-SD_3. The source drivers SD_1-SD_3 receive the clock signal CLK and the data signal DATA, respectively. There is a respective first skew value between the received clock signal CLK and the received data signal DATA for each source driver, wherein the respective first skew value of each source driver may be a factory default value provided by the manufacturer or a fixed common default skew value. In an embodiment of the invention, each source driver adjusts the respective first skew value to a respective second skew value.

In brief, compared with the conventional display driving apparatus using a fixed common default skew value, each source driver of the display driving apparatus 20 adjusts the respective first skew value to a respective second skew value for providing an optimum and suitable skew value so as to accurately acquire data from the tinning controller 202.

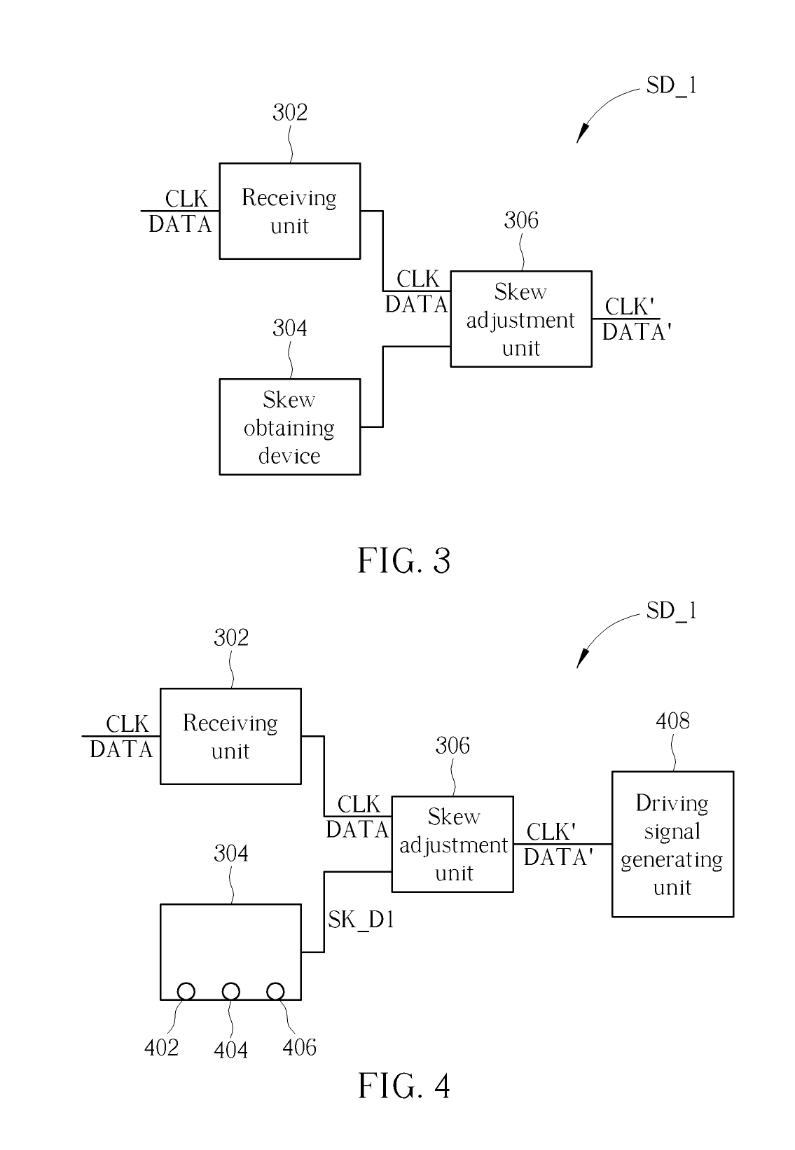

Please refer to FIG. 3, which is a schematic diagram of an alternative embodiment of the source driver SD_1 shown in FIG. 2. The source driver SD_1 includes a receiving unit 302, a skew obtaining device 304 and a skew adjustment unit 306. The receiving unit 302 is utilized for receiving a clock signal CLK and a data signal DATA, wherein there is a first skew value between the clock signal CLK and the data signal DATA. The skew obtaining device 304 is utilized for obtaining a second skew value. The skew adjustment unit 306 is utilized for delaying at least one of the received clock signal CLK and the received data signal DATA to generate a respective clock signal CLK′ and a respective data signal DATA′ according to the second skew value, wherein there is the second skew value between the respective clock signal CLK′ and the respective data signal DATA′.

In more detail, each source driver of the display driving apparatus 20 receives respective skew setting data from external devices and adjusts the respective first skew value to the respective second skew value according to the respective skew setting data. Please refer to FIG. 4, which is a schematic diagram of an alternative embodiment of the source driver SD_1 shown in FIG. 3. The skew obtaining device 304 includes input pins 402, 404, 406. The input pins 402, 404, 406 are utilized for receiving respective skew setting data SK_D1 from external devices. The skew setting data SK_D1 indicates the second skew value of the source driver SD_1. Furthermore, the skew adjustment unit 306 delays at least one of the received clock signal CLK and the received data signal DATA to generate a respective clock signal CLK′ and a respective data signal DATA′ according to the skew setting data SK_D1. In other words, each source driver receives the respective skew setting data from the external devices via the input pins and accordingly adjusts the received signals without using a fixed common default skew value for avoiding data access failures.

In addition, as shown in FIG. 4, the source driver SD_1 further includes a driving signal generating unit 408. The driving signal generating unit 408 is coupled to the skew adjustment unit 306 for generating one or more source driving signals according to the clock signal CLK′ and the data signal DATA′.

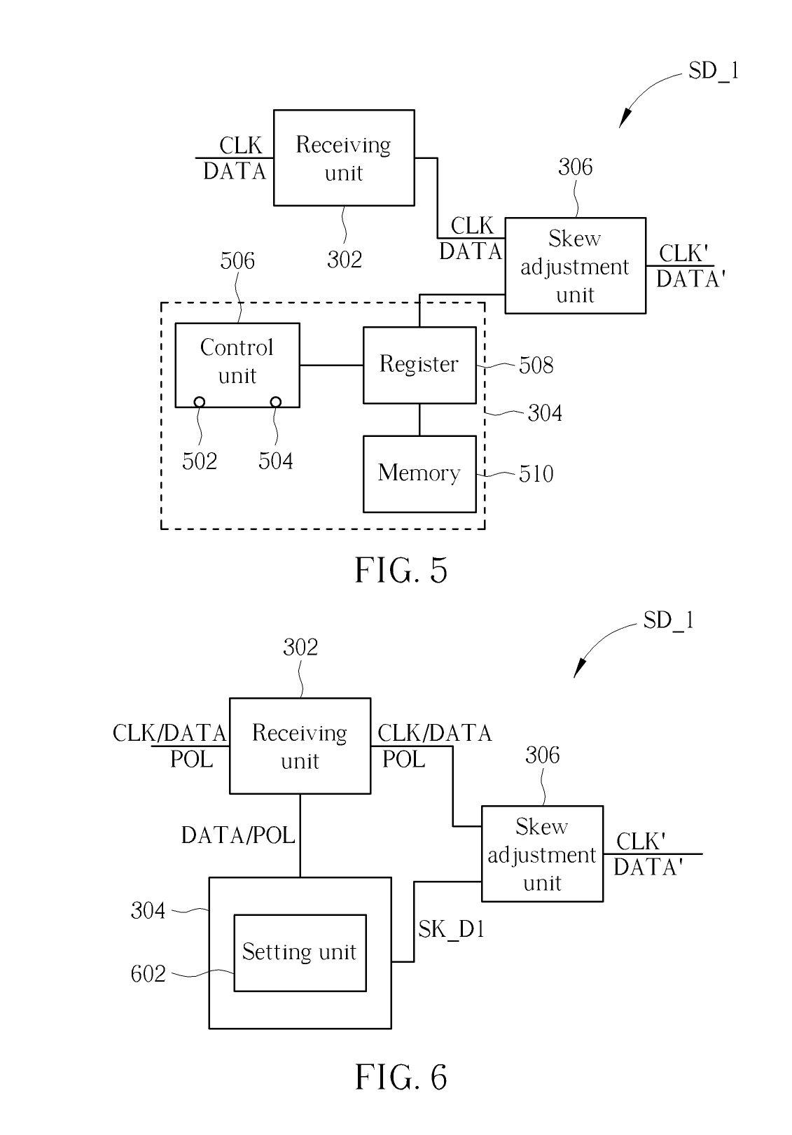

Please refer to FIG. 5, which is a schematic diagram of an alternative embodiment of the source driver SD_1 shown in FIG. 3. As shown in FIG. 5, the skew obtaining device 304 includes input pins 502, 504, a control unit 506 and a register 508. The input pins 502, 504 are utilized for receiving respective skew setting data SK_D1 from external devices. The skew setting data SK_D1 indicates the second skew value of the source driver SD_1. The control unit 506 is coupled to the input pins 502, 504 for obtaining the skew setting data SK_D1 via the input pins 502, 504. The register 508 is coupled to the control unit 506 and the skew adjustment unit 306. The register 508 is utilized for temporarily storing the skew setting data SK_D1 and transmitting the skew setting data SK_D1 to the skew adjustment unit 306. Therefore, the skew adjustment unit 306 delays at least one of the received clock signal CLK and the received data signal DATA to generate a respective clock signal CLK′ and a respective data signal DATA′ according to the skew setting data SK_D1.

In addition, as shown in FIG. 5, the skew obtaining device 304 further includes a memory 510. The memory 510 is coupled to the register 508 for storing the skew setting data SK_D1. The memory 510 may be a multiple times programmable (MTP) memory or any kind of memory device.

Preferably, the input pins 402, 404, 406, 502, 504 can be skew setting dedicated pins, communication interface pins or signal input pins communicating with a timing controller, but this should not be a limitation of the invention. For example, the input pins 502 and 504 may be communication interface pins respectively, e.g., the input pins 502 and 504 may be a serial data line (SDA) pin and a serial clock line (SCL) pin of an Inter-Integrated Circuit (I²C), respectively. The input pins 502 and 504 may be signal input pins communicating with a timing controller 202, e.g., the input pins 502 and 504 may be a pin connected to a differential signal line (e.g. a differential signal line LV0) of the timing controller and a pin connected to a data latch signal line (e.g. a data latch signal line LD) of the timing controller, respectively.

On the other hand, before acquiring the data signal, e.g. during a blanking period, each source driver may utilize the received clock signal CLK and the received data signal DATA to determine the respective second skew value and adjust the respective first skew value to the respective second skew value automatically, so as to provide sufficient setup/hold time margins for accurately receiving data transmitted from a timing controller. Please refer to FIG. 6, which is a schematic diagram of an alternative embodiment of the source driver SD_1 shown in FIG. 3. During a blanking period, the receiving unit 302 receives at least one of a data signal DATA and a polarity control signal POL, and transmits the received data signal DATA and/or the received polarity control signal POL to the skew obtaining device 304. The skew obtaining device 304 further includes a setting unit 602. The setting unit 602 controls the source driver SD_1 to enter a skew setting reset state according to a skew setting reset signal of the received signals. After the source driver SD_1 enters the skew setting reset state, the skew obtaining device 304 reads the skew setting data SK_D1 from a skew setting data section. The skew setting data SK_D1 indicates the second skew value of the source driver SD_1. In other words, during the blanking period, the source driver SD_1 can obtain the corresponding skew setting data from the data signal DATA and/or the polarity control signal POL after being triggered by the skew setting reset signal. Therefore, the skew adjustment unit 306 delays at least one of the clock signal CLK and the data signal DATA to generate a respective clock signal CLK′ and a respective data signal DATA′ according to the skew setting data SK_D1.

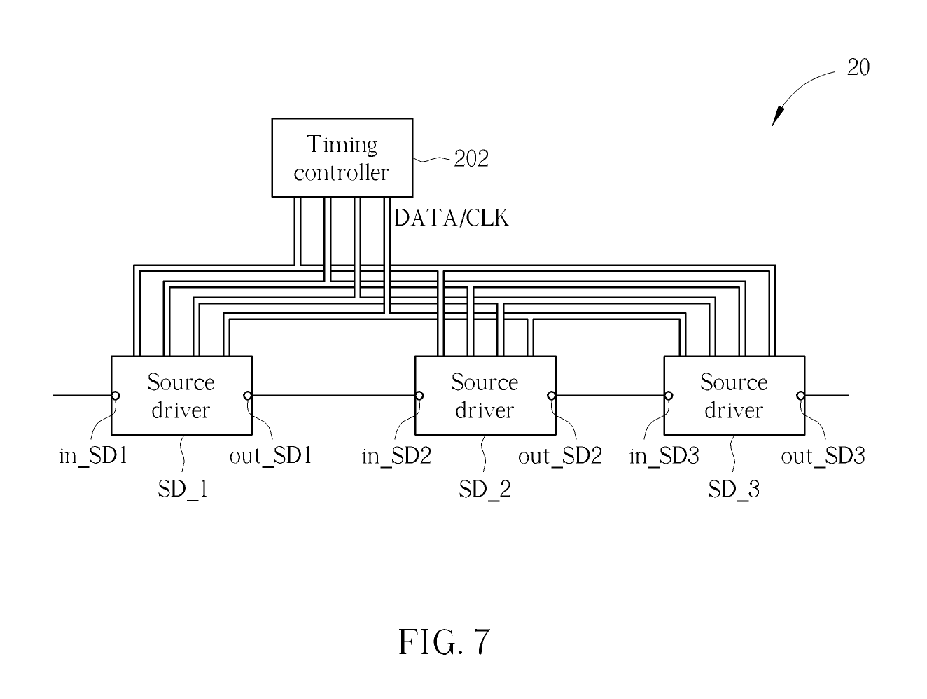

Further, when the skew obtaining device 304 obtains the skew setting data SK_D1, the source driver SD_1 may generate an input/output start signal to a next-stage source driver for controlling the next-stage source driver for obtaining the corresponding skew setting data. For example, please refer to FIG. 7, which is a schematic diagram of an alternative embodiment of the display driving apparatus 20 shown in FIG. 2. As shown in FIG. 7, after the skew obtaining device 304 obtains the skew setting data SK_D1, the source driver SD_1 generates an input/output start signal DIO_SD1 and outputs the input/output start signal DIO_SD1 via an output terminal out_SD1 to an input terminal in_SD2 of the source driver SD_2, to trigger the source driver SD_2 to start obtaining the corresponding skew setting data SK_D2. Similarly, after the source driver SD_2 obtains the skew setting data SK_D2, the source driver SD_2 generates an input/output start signal DIO_SD2 to trigger the source driver SD_3 to start obtaining the corresponding skew setting data SK_D3, and so on.

In more detail, please further refer to FIG. 6. If the data signal DATA received by the receiving unit 302 shown in FIG. 6 includes differential signals LV0-LV5 (take six differential signals for example, but this is not a limitation of the present invention). One of the differential signals LV0-LV5 and the polarity control signal POL includes a skew setting reset section RST. The skew setting reset section RST includes a skew setting reset signal RESET. One of the differential signals LV0-LV5 and the polarity control signal POL includes a skew setting data section RST_DATA. The skew setting data section RST_DATA includes skew setting data SK_D1. Preferably, an end point of the skew setting reset section RST is prior to an initial point of the skew setting data section RST_DATA. If one of the differential signals LV0-LV5 includes a data reset section and the data reset section includes a data reset signal DMR, the data reset section does not overlap with the skew setting reset section RST. If the polarity control signal POL includes the skew setting reset section RST, the skew setting reset section RST is not in a positive transition period of a data latch signal.

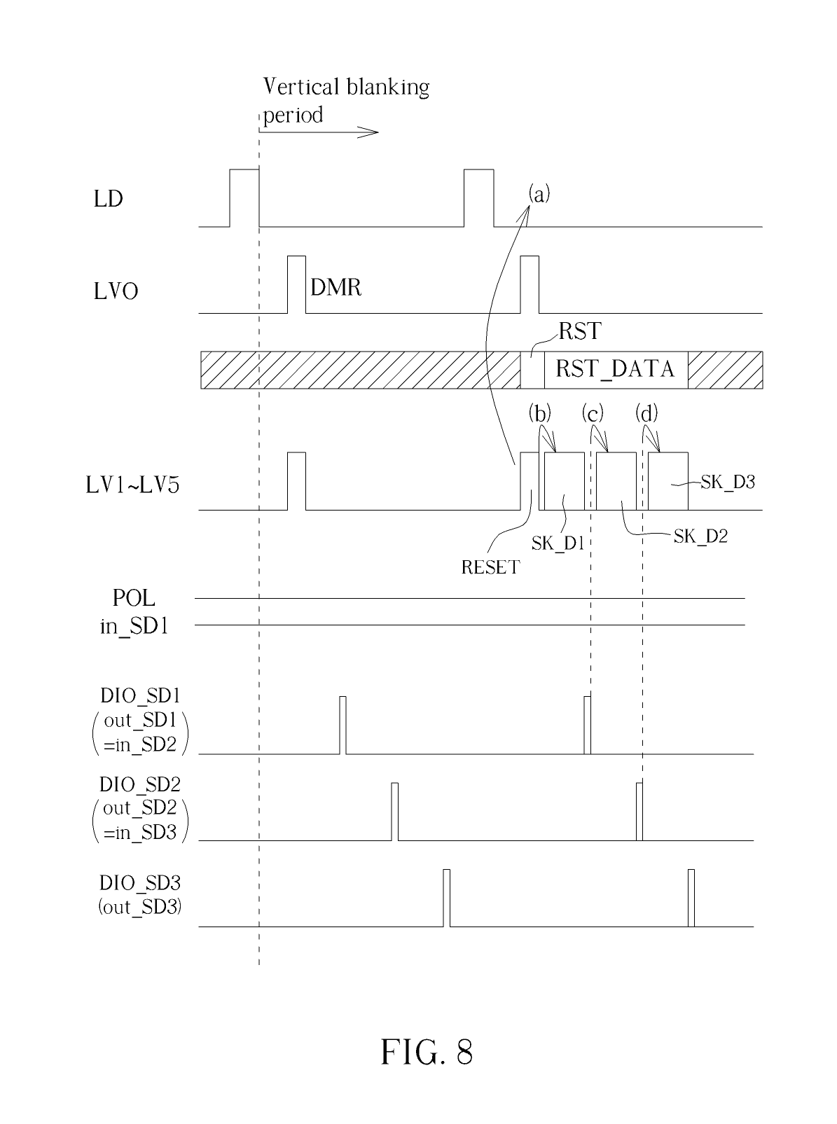

For example, FIGS. 8-11 are respectively timing diagrams of the source driver SD_1 shown in FIG. 6 according to alternative embodiments of the present invention. As shown in FIG. 8, at least one of differential signals LV1-LV5 includes a skew setting reset section RST and the skew setting reset section RST includes a skew setting reset signal RESET. Moreover, at least one of the differential signals LV1-LV5 includes a skew setting data section RST_DATA and the skew setting data section RST_DATA includes skew setting data SK_D1. In other words, the skew setting reset section RST and the skew setting data section RST_DATA are arranged among the differential signals LV1-LV5.

Further, as shown in FIG. 8, the timing controller 202 outputs a data latch signal LD (e.g., the data latch signal LD turns high) during a vertical blanking period. After that, the timing controller 202 outputs the skew setting reset signal RESET included in the differential signals LV1-LV5, so as to trigger the source driver SD_1 to start receiving the skew setting data SK_D1. Therefore, after the receiving unit 302 receives the data latch signal LD (e.g., the data latch signal LD turns high) during the vertical blanking period, the receiving unit 302 starts to receive the skew setting reset signal RESET from the skew setting reset section RST of the differential signals LV1-LV5. The setting unit 602 controls the source driver SD_1 to enter a skew setting reset state according to the skew setting reset signal RESET after the receiving unit 302 receives the skew setting reset signal RESET (as shown in Step(a) of FIG. 8). When the source driver SD_1 enters the skew setting reset state, the skew obtaining device 304 reads the skew setting data SK_D1 from the skew setting data section RST_DATA (as shown in Step(b) of FIG. 8). In other words, the skew setting reset signal RESET is utilized for triggering the skew obtaining device 304 of the source driver SD_1 to receive the skew setting data SK_D1. Accordingly, the skew adjustment unit 306 delays the received clock signal CLK and/or the received data signal DATA to generate a respective clock signal CLK′ and a respective data signal DATA′ according to the skew setting data SK_{—} D1.

Please further refer to FIGS. 7-8, after the data latch signal LD and the skew setting reset signal RESET are received and determined by the source driver SD_1, the source driver SD_1 receives the skew setting data SK_D1 accordingly. Moreover, the following source drivers SD_2-SD_3 can decide when to receive the corresponding skew setting data according to an input/output start signal. For example, after completing receiving the skew setting data SK_D1, the source driver SD_1 outputs the input/output start signal DIO_SD1 via the output terminal out_SD1 to the input terminal in_SD2 of the source driver SD_2, to trigger the source driver SD_2 to start receiving the corresponding skew setting data SK_D2. The source driver SD_2 starts to receive the corresponding the skew setting data SK_D2 (as shown in Step(c) of FIG. 8) after receiving the input/output start signal DIO_SD1. Similarly, after completing receiving the skew setting data SK_D2, the source driver SD_2 transmits the input/output start signal DIO_SD2 via the output terminal out_SD2 to the input terminal in_SD3 of the source driver SD_3, to trigger the source driver SD_3 to start receiving the corresponding skew setting data SK_D3. The source driver SD_2 starts to receive the corresponding the skew setting data SK_D3 after receiving the input/output start signal DIO_SD2 (as shown in Step(d) of FIG. 8).

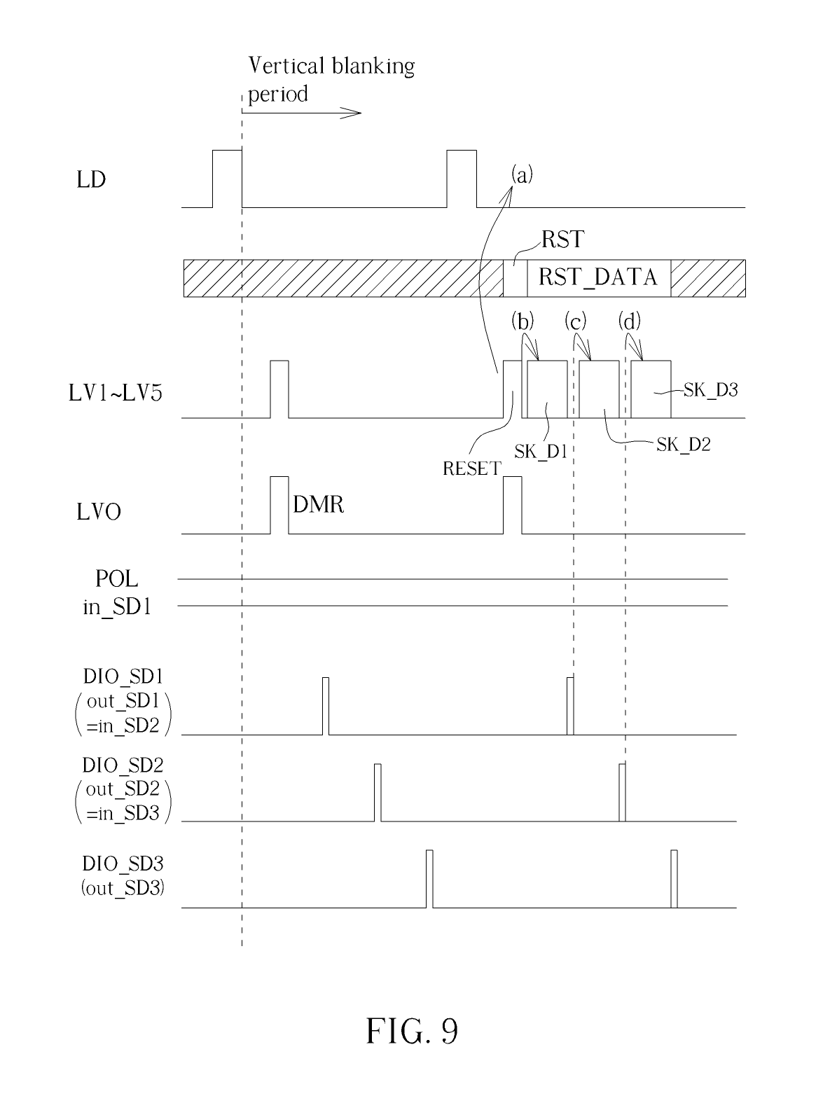

In addition, the skew setting reset section RST can be arranged in other signals. For example, the skew setting reset section RST may be included in the differential signal LV0 or the polarity control signal POL. The differential signal LV0 may include a data reset signal DMR for controlling the source driver SD_1 to enter a data mode reset state. For example, please refer to FIG. 9. The skew setting reset section RST and the skew setting data section RST_DATA are arranged in the differential signals LV0. As shown in FIG. 9, the differential signals LV0 includes the skew setting reset section RST and the skew setting reset section RST includes a skew setting reset signal RESET. Moreover, the differential signals LV0 includes a skew setting data section RST_DATA and the skew setting data section RST_DATA includes skew setting data SK_D1. Similarly, after receiving the data latch signal LD (e.g., the data latch signal LD is high), the receiving unit 302 receives the skew setting reset signal RESET from the skew setting reset section RST of the differential signal LV0. When the receiving unit 302 receives the skew setting reset signal RESET, the source driver SD_1 enters a skew setting reset state according to the skew setting reset signal RESET. As such, the skew obtaining device 304 reads the skew setting data SK_D1 from the skew setting data section RST_DATA.

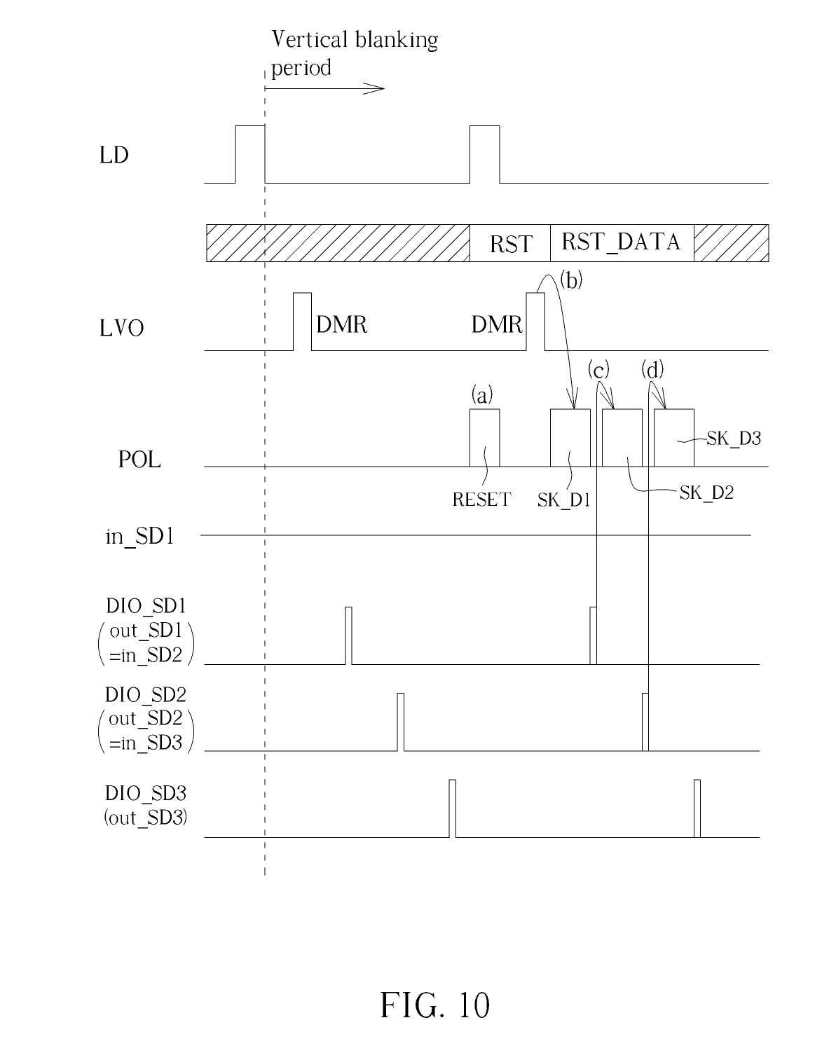

Please refer to FIG. 10. The skew setting reset section RST and the skew setting data section RST_DATA are arranged in the polarity control signal POL. As shown in FIG. 10, the polarity control signal POL includes the skew setting reset section RST and the skew setting reset section RST includes a skew setting reset signal RESET. Moreover, the polarity control signal POL includes a skew setting data section RST_DATA and the skew setting data section RST_DATA includes skew setting data SK_D1. The skew setting reset section RST is after a positive transition period of a data latch signal LD. The skew setting reset section RST is between the positive transition period and a negative transition period of the data latch signal LD. After the receiving unit 302 receives and detects a positive transition of the data latch signal LD (e.g., the data latch signal LD turns high), the receiving unit 302 receives the skew setting reset signal RESET from the skew setting reset section RST of the polarity control signal POL. When the receiving unit 302 receives the skew setting reset signal RESET, the source driver SD_1 enters a skew setting reset state according to the skew setting reset signal RESET. Therefore, the skew obtaining device 304 reads the skew setting data SK_D1 from the skew setting data section RST_DATA.

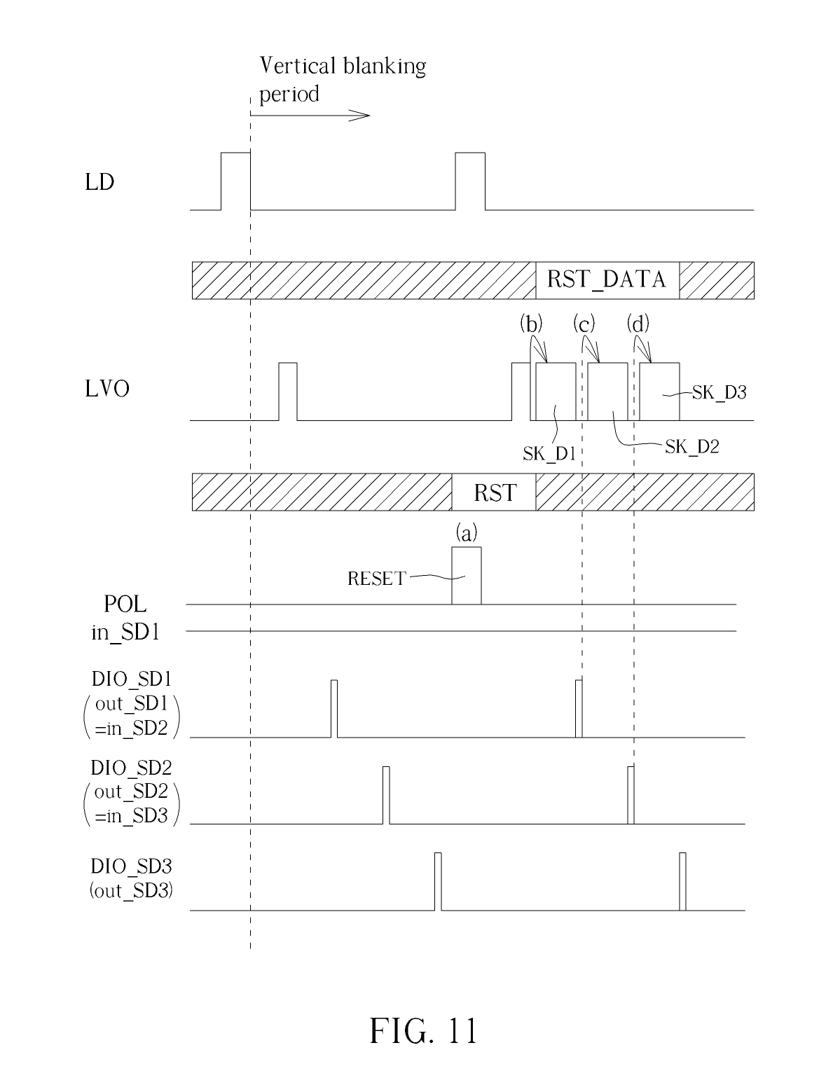

As shown in FIGS. 8-10, the skew setting reset section RST and the skew setting data section RST_DATA are simultaneously arranged in the polarity control signal POL or the differential signals. Besides, the skew setting reset section RST may be arranged in one of the polarity control signal POL and the differential signals LV0-LV5, and the skew setting data section RST_DATA may be arranged in another one of the polarity control signal POL and the differential signals LV0-LV5. For example, please refer to FIG. 11. The skew setting reset section RST is arranged in the polarity control signal POL. The skew setting data section RST_DATA is arranged in the differential signal LV0. Similarly, the source driver SD_1 enters a skew setting reset state according to the skew setting reset signal RESET, and the skew obtaining device 304 reads the skew setting data SK_D1 from the skew setting data section RST_DATA.

To sum up, the invention can provide the corresponding skew setting data included in the polarity control signal or the differential signal for each source driver. Therefore, each source driver can obtain the corresponding skew setting data from the polarity control signal or the differential signal period during the blanking according to the skew setting reset signal. Therefore, each source driver can adjust the received clock signal and the received data signal according to the corresponding skew setting data, so as to accurately acquire data from the tinning controller.

On the other hand, since each the source driver does know the actual skew value between the received data signal and the received clock signal, and the fixed common default skew value may not be appropriate for all source drivers. If the source driver cannot obtain appropriate reference skew information, data access error may occur in the source driver. The source driver of the invention can perform an automatic skew scanning process to select an optimum and appropriate skew value before starting to acquire data signal (e.g. during a blanking period) for accurately receiving data from the tinning controller 202.

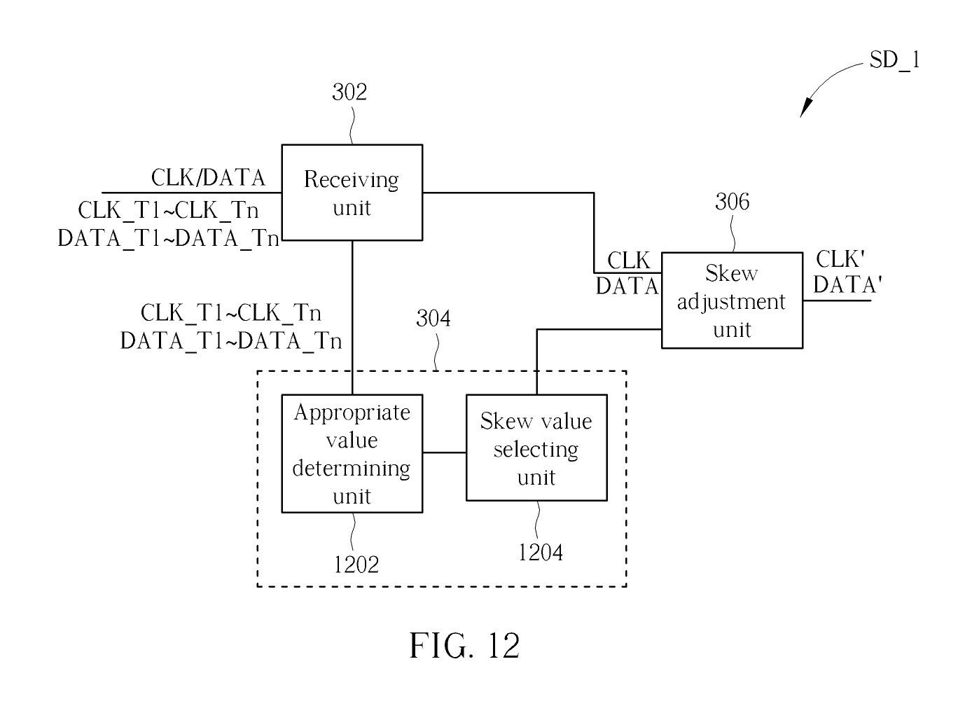

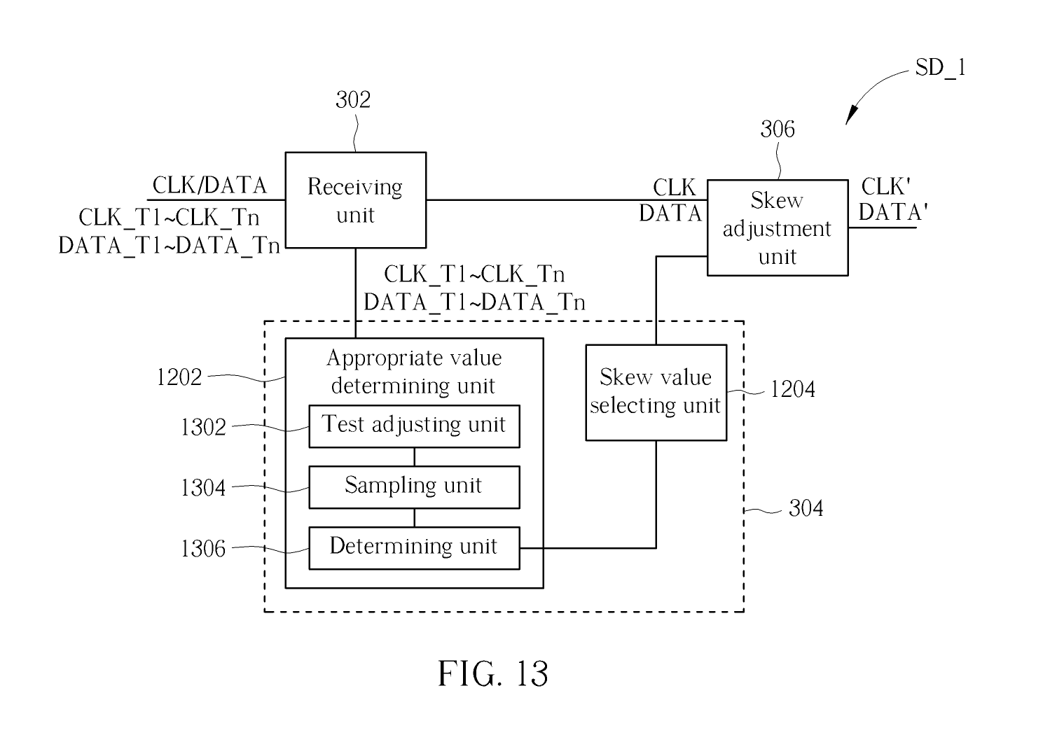

Please refer to FIGS. 12-13. FIG. 12 is a schematic diagram of an alternative embodiment of the display driving apparatus 20 shown in FIG. 3. FIG. 13 is a schematic diagram of an alternative embodiment of the skew obtaining device 304 shown in FIG. 12. In an embodiment, the receiving unit 302 receives test clock signals CLK_T1-CLK_Tn and test data signals DATA_T1-DATA_Tn, wherein each test data signal includes test data. There is a same first skew value between each test data signal and each corresponding test clock signal. Preferably, the test clock signals CLK_T1-CLK_Tn may be the same test clock signals, the test data signals DATA_T1-DATA_Tn may be the same test data signals and each test data signal includes the same test data. The skew obtaining device 304 selects one of the candidate skew values SK1˜SKn for acting as a second skew value of the source driver according to the test clock signals CLK_T1-CLK_Tn and the test data signals DATA_T1-DATA_Tn. In brief, without increasing circuit complexity of the timing controller, the source driver of the embodiment can chose and set the optimum and appropriate skew value automatically by verifying test clock signals and test data signals so as to ensure that sufficient timing margins are available for accurately receiving data.

As shown in FIG. 12, the skew obtaining device 304 includes an appropriate value determining unit 1202 and a skew value selecting unit 1204. Under the same first skew value, the appropriate value determining unit 1202 adjusts the first skew value to different candidate skew values SK1-SKn. The appropriate value determining unit 1202 adjusts the test clock signals CLK_T1-CLK_Tn and the corresponding test data signals DATA_T1-DATA_Tn according to the candidate skew values SK1-SKn respectively, performs data sampling processes accordingly for acquiring data included in the test data signals and determines whether the received test data signals are correct respectively, so as to select one or more appropriate skew values from the candidate skew values SK1-SKn. The skew value selecting unit 1204 is utilized for selecting a second skew value from the one or more appropriate skew values.

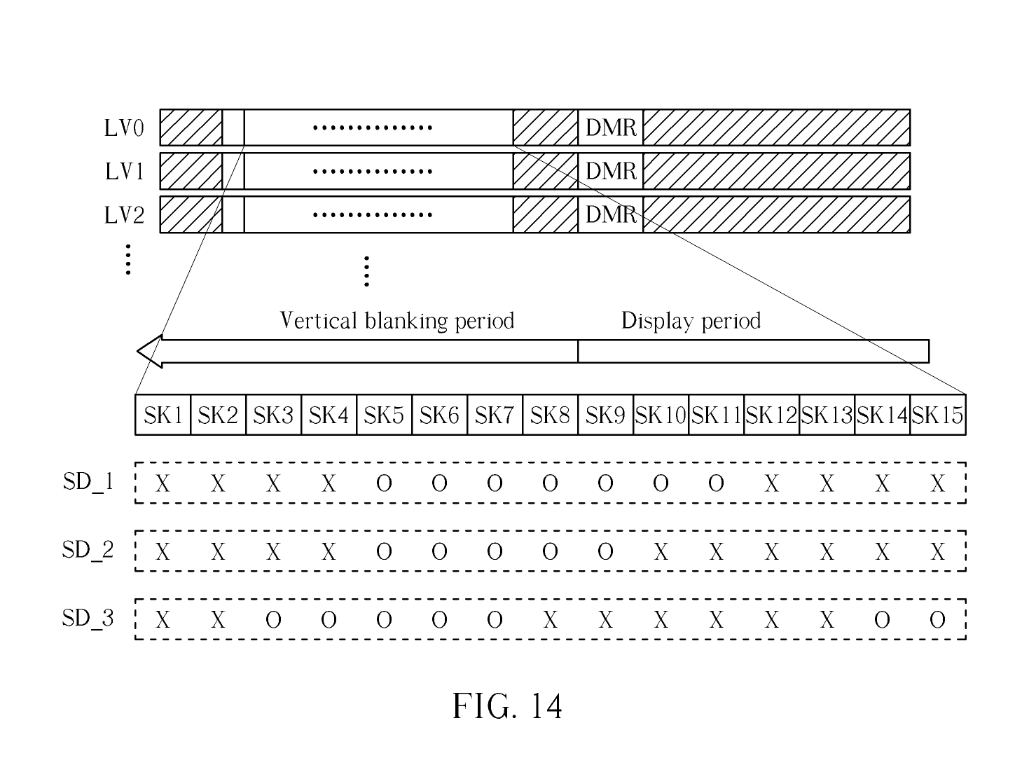

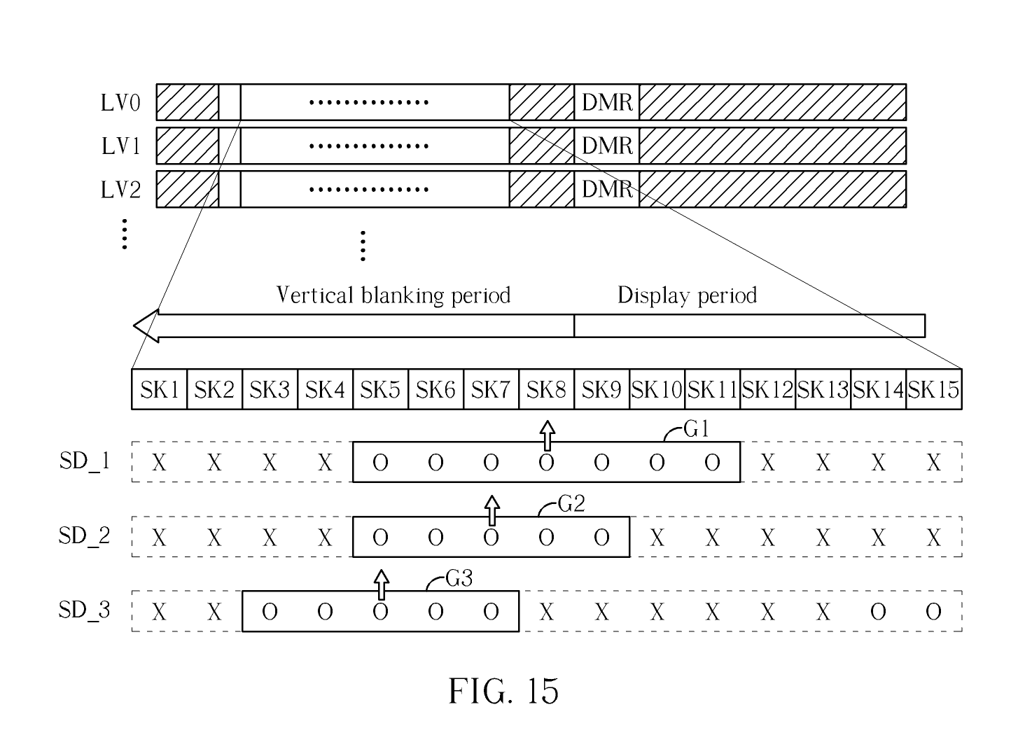

Please further refer to FIG. 13. The appropriate value determining unit 1202 includes a test adjusting unit 1302, a sampling unit 1304 and a determining unit 1306. The test adjusting unit 1302 is utilized for adjusting the first skew value to different candidate skew values SK1-SKn, e.g., the candidate skew values SK1˜SK15 shown in FIG. 14. The test adjusting unit 1302 delays at least one of a first test data signal of the test data signals DATA_T1-DATA_Tn and a first test clock signal of the test clock signals CLK_T1-CLK_Tn according to a first candidate skew value of the candidate skew values SK1-SKn, so as to generate an adjusted first test clock signal and an adjusted first test data signal. The sampling unit 1304 is utilized for performing data sampling of the adjusted first test data signal with the adjusted first test clock signal for acquiring first data included in the first test data signal. The determining unit 1306 is utilized for determining whether the first data is identical to the test data. If the first data is identical to the test data, the determining unit 1306 determines that the first candidate skew value is one of the one or more appropriate skew values. Such like this, the appropriate value determining unit 1202 adjusts the test clock signal and test clock signal according to each candidate skew value, samples and compares data included in the adjusted test data signal for obtaining related appropriate skew values.

For example, if the test data included in the test data signal DATA_T1 is “101”. The test adjusting unit 1302 delays at least one of the test data signal DATA_T1 and the test clock signal CLK_T1 according to the candidate skew value SK1, so as to generate an adjusted test clock signal DATA_T1 and an adjusted test data signal CLK_T1. The sampling unit 1304 performs data sampling of the adjusted test data signal DATA_T1 with the adjusted test clock signal CLK_T1 for acquiring sampling data included in the adjusted test clock signal DATA_T1. The determining unit 1306 determines whether the acquired sampling data is identical to the test data included in the test data signal DATA_T1. That is, the determining unit 1306 determines whether the acquired sampling data is “101”. If the acquired sampling data is “101”, that means the data is correctly received by the source driver. Therefore, the source driver SD_1 can adjust the data signal and the corresponding clock signal by using the candidate skew value SK1 for acquiring data accurately. As such, the candidate skew value SK1 is determined as one appropriate skew value.

Please refer to FIG. 14, which is a schematic diagram of an automatic skew scanning according to an embodiment of the present invention. Take source driver SD_1 for example, if the corresponding test data signal and test clock signal are adjusted according to each of the candidate skew values SK1-S15, and related data sampling and comparison process are performed accordingly, such that the candidate skew values SK5-SK11 are selected as appropriate skew values. Therefore, each of the candidate skew values SK5-SK11 is substantially considered to be a corresponding skew value of the source driver SD_1. Similarly, the candidate skew values SK5-SK9 are selected as appropriate skew values for the source driver SD_2, and each of the candidate skew values SK5-SK9 is substantially considered to be a corresponding skew value of the source driver SD_2. The candidate skew values SK3-SK7 and SK14-SK15 are selected as appropriate skew values for the source driver SD_3, and each of the candidate skew values SK3-SK7 and SK14-SK15 is substantially considered to be a corresponding skew value of the source driver SD_3.

For obtaining an optimal skew value for each source driver, the skew value selecting unit 1204 may chose a median of the appropriate skew values as a second skew value of the each source driver. For example, the candidate skew value SK8 may be selected as the second skew value of the source driver SD_1, the candidate skew value SK7 may be selected as the second skew value of the source driver SD_2 and the candidate skew value SK6 may be selected as the second skew value of the source driver SD_3.

Further, the appropriate skew values may be sorted in order by the skew value selecting unit 1204. The skew value selecting unit 1204 selects an appropriate skew value group from the sorted appropriate skew values. The appropriate skew value group includes at least two adjacent appropriate skew values. The skew value selecting unit 1204 may select the second skew value in the appropriate skew value group. For example, the skew value selecting unit 1204 may chose a median of the appropriate skew value group as a second skew value of the source driver. Please refer to FIG. 15, the skew value selecting unit 1204 selects an appropriate skew value group G1 and selects the median of the appropriate skew value group G1 as the second skew value of the source driver SD_1, e.g., the candidate skew value SK8 is selected as the second skew value of the source driver SD_1. Similarly, the skew value selecting unit 1204 selects an appropriate skew value group G2 and selects the median of the appropriate skew value group G2 as the second skew value of the source driver SD_2, e.g., the candidate skew value SK7 is selected as the second skew value of the source driver SD_2. The skew value selecting unit 1204 selects an appropriate skew value group G3 and selects the median of the appropriate skew value group G3 as the second skew value of the source driver SD_3, e.g., the candidate skew value SK5 is selected as the second skew value of the source driver SD_3.

The following further elaborates operations of the automatic skew scanning process. The data signal DATA received by the receiving unit 302 shown in FIG. 12 includes the differential signals LV0-LV5 (six differential signals are shown here for exemplary purposes, but this is not limited thereto). One of the polarity control signal POL and the differential signals LV0-LV5 includes an automatic skew setting reset section A_RST. The automatic skew setting reset section A_RST includes an automatic skew setting reset signal A_RESET. After receiving the automatic skew setting reset signal A_RESET, the source drivers SD_1-SD_3 respectively enter an automatic skew scanning state and receive the test clock signals CLK_T1-CLK_Tn and the test data signals DATA_T1-DATA_Tn. The source driver SD_1 selects one of the candidate skew values SK1-SKn for acting as the corresponding second skew value according to the received test clock signals CLK_T1-CLK_Tn and the received test data signals DATA_T1-DATA_Tn.

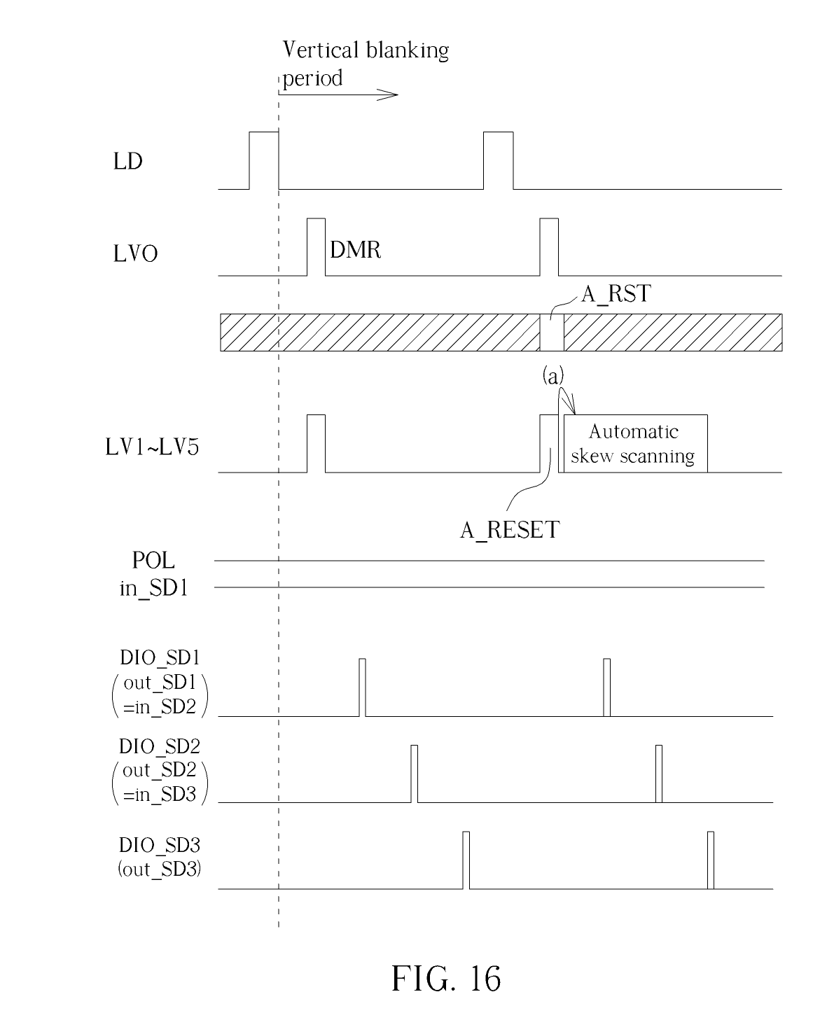

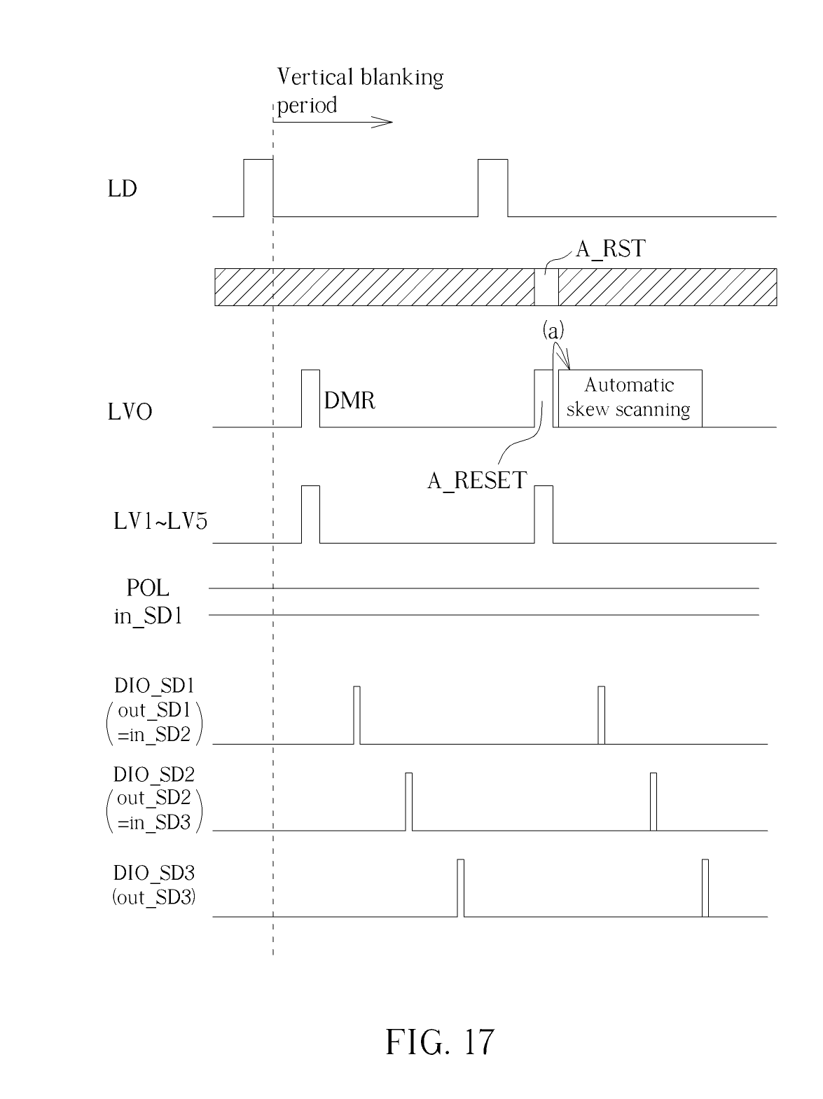

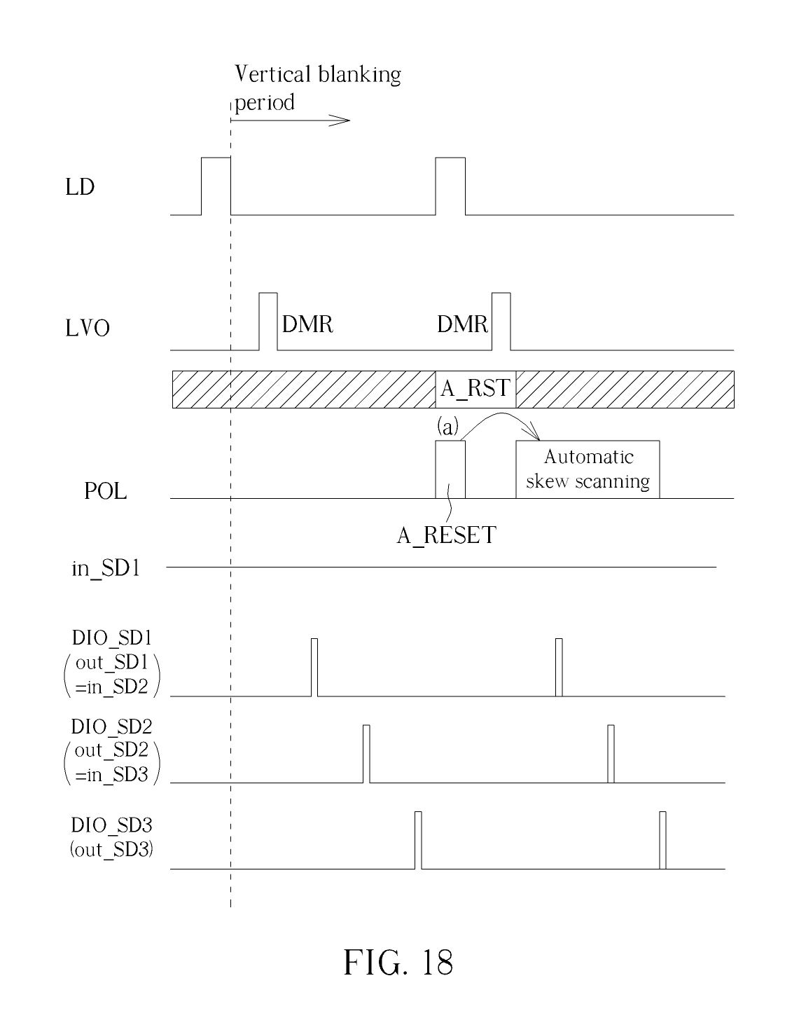

As shown in FIG. 16, during a vertical blanking period, the timing controller 202 outputs a data latch signal LD and outputs the automatic skew setting reset signal A_RESET included in the differential signals LV1-LV5, so as to trigger the source drivers SD_1-SD_3 to start receiving the automatic skew setting reset signal A_RESET. Accordingly, each source driver receives the automatic skew setting reset signal A_RESET in the differential signals LV1-LV5 after receiving the data latch signal LD during the vertical blanking period. Each source driver enters an automatic skew scanning state according to the automatic skew setting reset signal A_RESET after receiving the automatic skew setting reset signal A_RESET (as shown in Step(a) of FIGS. 16-18). Each source driver selects one of the candidate skew values SK1-SKn for acting as the corresponding second skew value according to the received test clock signals and the received test data signals. Similarly, as shown in FIGS. 17-18, the automatic skew setting reset signals A_RESET are arranged in the polarity control signal POL and the differential signal LV0 respectively. Each source driver enters an automatic skew scanning state accordingly after receiving the automatic skew setting reset signal A_RESET and selects one of the candidate skew values for acting as the corresponding second skew value according to the received test clock signals and the received test data signals.

Moreover, in the timing controller 102, there is an initial skew value between the clock signal CLK and the data signal DATA for each source driver. The timing controller 102 maintains the initial skew value. Under the same initial skew value corresponding to the same respective first skew value, the skew obtaining device 304 adjusts the respective first skew value to a plurality of candidate skew values and determines whether the received test data signals are correct according to the candidate skew values respectively, so as to select one or more appropriate skew values from the candidate skew values. The skew obtaining device 304 may select a second skew value from the one or more appropriate skew values. Besides, in the timing controller 102, there is an initial skew value between the clock signal CLK and the data signal DATA for each source driver. The timing controller 102 adjusts the initial skew value to different skew values with different values. Under the different initial skew values corresponding to the respective first skew values with different values, the skew obtaining device 304 determines whether the received test data signals are correct so as to select one or more appropriate skew values from the candidate skew values. Similarly, the skew obtaining device 304 may select a second skew value from the one or more appropriate skew values.

Note that, the abovementioned operations of the source driver SD_1 is merely an exemplary embodiment for illustrative purposes, and should not be considered to be limitations of the scope of the present invention. The same operation can also be applied in other source driver. In addition, the timing controller 102 may be connected to the source drivers in a multi-drop architecture or in a point-to-point architecture. The transmission interface between the timing controller and the source may be a mini low-voltage differential signaling (mini-LVDS) interface or a reduced swing differential signal (RSDS) interface, but this should not be a limitation of the invention.

In summary, since the conventional display driving apparatus uses a fixed common default skew value for all connected source drivers, data access failures and display errors may occur. In comparison, the source driver of the invention can receive the respective skew setting data from the external devices via the input pins and accordingly adjusts the received signals without using a fixed common default skew value for avoiding data access failures. Moreover, the source driver of the invention can determine the respective skew value according to the received clock signal and data signal, so as to provide sufficient setup/hold time margins for accurately receiving data transmitted from a timing controller. Besides, the source driver of the invention can chose and set the optimum and appropriate skew value automatically by verifying test signals so as to ensure that sufficient timing margins are available for accurately receiving data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display driving apparatus, comprising:
a timing controller, for generating and outputting a first clock signal and a first data signal; and
a plurality of source drivers, each source driver receiving the first clock signal and the first data signal, wherein there is a respective first skew value between the received first clock signal and the received first data signal for each source driver;
wherein each source driver adjusts the respective first skew value to a respective second skew value.

2. The display driving apparatus of claim 1, wherein each source driver receives respective skew setting data from external devices and adjusts the respective first skew value to the respective second skew value according to the respective skew setting data.

3. The display driving apparatus of claim 2, wherein each source driver comprises:
at least one input pin, for receiving the respective skew setting data from the external devices; and
a skew adjustment unit, coupled to the at least one input pin, for delaying at least one of the received first clock signal and the received first data signal to generate a respective second clock signal and a respective second data signal, wherein there is the respective second skew value between the respective second clock signal and the respective second data signal for each source driver.

4. The display driving apparatus of claim 3, wherein the at least one input pin is a skew setting dedicated pin, a communication interface pin or a signal input pin communicating with the timing controller.

5. The display driving apparatus of claim 1, wherein each source driver determines the respective second skew value according to the received first clock signal and the received first data signal and adjusts the respective first skew value to the respective second skew value automatically.

6. The display driving apparatus of claim 5, wherein each source driver comprises:
a skew obtaining unit, for determining the respective second skew value according to the received first clock signal and the received first data signal; and
a skew adjustment unit, coupled to the skew obtaining unit, for delaying at least one of the received first clock signal and the received first data signal to generate a respective second clock signal and a respective second data signal, wherein there is the respective second skew value between the respective second clock signal and the respective second data signal for each source driver.

7. The display driving apparatus of claim 6, wherein, in the timing controller, there is an initial skew value between the first clock signal and the first data signal, the timing controller maintains the initial skew value, and the skew obtaining unit of each source driver performs the following steps for determining the respective second skew value, the steps comprises:
under the same initial skew value corresponding to the same respective first skew value, adjusting the respective first skew value to a plurality of candidate skew values and determining whether the received first data signal is correct respectively, so as to select one or more appropriate skew values from the candidate skew values; and
selecting the respective second skew value from the one or more appropriate skew values.

8. The display driving apparatus of claim 6, wherein, in the timing controller, there is an initial skew value between the first clock signal and the first data signal, the timing controller adjusts the initial skew value to different skew values, and the skew obtaining unit of each source driver performs the following steps for determining the respective second skew value, the steps comprises:
under the different initial skew values corresponding to the respective first skew values with different values, determining whether the received first data signal is correct respectively, so as to select one or more appropriate skew values from the candidate skew values; and
selecting the respective second skew value from the one or more appropriate skew values.

9. A source driver, comprising:
a receiving unit, for receiving a first clock signal and a first data signal, wherein there is a first skew value between the first clock signal and the first data signal;
a skew obtaining device, for obtaining a second skew value; and
a skew adjustment unit, coupled to the skew obtaining device, for delaying at least one of the received first clock signal and the received first data signal to generate a second clock signal and a second data signal according to the second skew value, wherein there is the second skew value between the second clock signal and the second data signal.

10. The source driver of claim 9, wherein the skew obtaining device comprises at least one input pin for receiving skew setting data from external devices, wherein the skew setting data indicates the second skew value.

11. The source driver of claim 10, further comprising:
a driving signal generating unit, coupled to the skew adjustment unit, for generating one or more source driving signals according to the second clock signal and the second data signal.

12. The source driver of claim 10, wherein the at least one input pin is a communication interface pin.

13. The source driver of claim 12, further comprising:
a control unit, coupled to the at least one input pin, for obtaining the skew setting data; and
a register, coupled to the control unit and the skew adjustment unit, for temporarily storing the skew setting data and transmitting the skew setting data to the skew adjustment unit.

14. The source driver of claim 13, further comprising:
a multi-time programmable memory, coupled to the register, for storing the skew setting data.

15. The source driver of claim 10, wherein the at least one input pin is a signal input pin communicating with the timing controller.

16. The source driver of claim 15, further comprising:
a control unit, coupled to the at least one input pin, for receiving the skew setting data; and
a register, coupled to the control unit and the skew adjustment unit, for temporarily storing the skew setting data and transmitting the skew setting data to the skew adjustment unit.

17. The source driver of claim 9, wherein:
the receiving unit receives at least one of the first data signal and a polarity control signal during a blanking period, the first data signal comprises a plurality of differential signals, one of the plurality of differential signals and the polarity control signal comprises a skew setting reset section, the skew setting reset section comprises a skew setting reset signal, one of the plurality of differential signals and the polarity control signal comprises a skew setting data section, the skew setting data section comprises skew setting data; and
the skew obtaining device comprises a setting unit, the setting unit controls the source driver to enter a skew setting reset state, wherein after the source driver enters the skew setting reset state, the skew obtaining device obtains the skew setting data from the skew setting data section, the skew setting data indicates the second skew value.

18. The source driver of claim 17, wherein the skew obtaining device obtains the skew setting data and generates an input/output start signal to a next-stage source driver for controlling the next-stage source driver for obtaining the corresponding skew setting data.

19. The source driver of claim 17, wherein an end point of the skew setting reset section is prior to an initial point of the skew setting data section.

20. The source driver of claim 17, wherein a first differential signal of the plurality of differential signals comprises a data reset section, the data reset section comprises a data reset signal, and a second differential signal of the plurality of differential signals comprises the skew setting reset section, wherein the data reset section does not overlap with the skew setting reset section.

21. The source driver of claim 17, wherein the polarity control signal comprises the skew setting reset section and the skew setting reset section is not in a positive transition period of a data latch signal.

22. The source driver of claim 9, wherein the receiving unit further receives a plurality of test clock signals and a plurality of test data signals, each test data signal comprises test data, and the skew obtaining device selects one of the plurality of candidate skew values as the second skew value of the source driver according to the plurality of test clock signals and the plurality of test data signals.

23. The source driver of claim 22, wherein there is a same first skew value between each test data signal and each corresponding test clock signal, the skew obtaining device further comprises:
an appropriate value determining unit, for adjusting the first skew value to a plurality of different candidate skew values under the same first skew value, adjusting the plurality of test clock signals and the plurality of test data signals according to the plurality of different candidate skew values respectively, performing data sampling processes accordingly for acquiring data included in the plurality of test data signals and determining whether the received test data signals are correct respectively, so as to select one or more appropriate skew values from the plurality of candidate skew values; and
a skew value selecting unit for selecting the second skew value from the one or more appropriate skew values.

24. The source driver of claim 23, wherein the appropriate value determining unit comprises:
a test adjusting unit, for adjusting the first skew value to a plurality of different candidate skew values and delaying at least one of a first test data signal of the plurality of test data signals and a first test clock signal of the plurality of test clock signals according to a first candidate skew value of the plurality of different candidate skew values, so as to generate an adjusted first test clock signal and an adjusted first test data signal;
a sampling unit, for performing data sampling of the adjusted first test data signal with the adjusted first test clock signal for acquiring first data included in the first test data signal; and
a determining unit, for determining whether the first data is identical to the test data and determining that the first candidate skew value is one of the one or more appropriate skew values when the first data is identical to the test data.

25. The source driver of claim 23, wherein the skew value selecting unit selects a median of the one or more appropriate skew values as the second skew value of the source driver.

26. The source driver of claim 23, wherein the skew value selecting unit sorts the one or more appropriate skew values in order and selects an appropriate skew value group from the sorted appropriate skew values, wherein the appropriate skew value group comprises at least two adjacent appropriate skew values and the skew value selecting unit selects the second skew value from the appropriate skew value group.

27. The source driver of claim 26, wherein the skew value selecting unit selects a median of the appropriate skew value group as the second skew value.

28. The source driver of claim 22, wherein the relations between the plurality of test clock signals and the plurality of test data signals correspond to the plurality of candidate skew values, the skew obtaining device further comprises:
an appropriate value determining unit, for performing data sampling processes according to the plurality of test data signals and corresponding test clock signals for acquiring data included in the plurality of test data signals and determining whether the received test data signals are correct respectively, so as to select one or more appropriate skew values from the plurality of candidate skew values; and
a skew value selecting unit for selecting the second skew value from the one or more appropriate skew values.

29. The source driver of claim 22, wherein:
the receiving unit receives at least one of the first data signal and a polarity control signal during a blanking period, the first data signal comprises a plurality of differential signals, one of the plurality of differential signals and the polarity control signal comprises an automatic skew setting reset section, the automatic skew setting reset section comprises an automatic skew setting reset signal; and
the skew obtaining device comprises a setting unit, the setting unit controls the source driver to enter an automatic skew scanning state, wherein after the source driver enters the automatic skew scanning state, the receiving unit receives the plurality of test clock signals and the plurality of test data signals, and accordingly, the skew obtaining device selects one of the plurality of candidate skew values as the second skew value of the source driver according to the plurality of test clock signals and the plurality of test data signals.

30. A skew adjustment method for a source driver, comprising:
receiving the first clock signal and the first data signal, wherein there is a first skew value between the first clock signal and the first data signal;
obtaining a second skew value; and
adjusting at least one of the first clock signal and the first data signal to generate an adjusted second clock signal and an adjusted second data signal, so that there is the second skew value between the adjusted second clock signal and the adjusted second data signal.

31. The skew adjustment method of claim 30, wherein the step of obtaining the second skew value comprises receiving skew setting data from the external devices via at least one input pin of the source driver.

32. The skew adjustment method of claim 30, wherein the step of obtaining the second skew value comprises determining the second skew value according to the first clock signal and the first data signal.

33. The skew adjustment method of claim 32, wherein the step of determining the second skew value according to the first clock signal and the first data signal comprises:
adjusting the respective first skew value to a plurality of candidate skew values and determining whether the received first data signal is correct respectively, so as to select one or more appropriate skew values from the candidate skew values; and
selecting the respective second skew value from the one or more appropriate skew values.

34. The skew adjustment method of claim 32, wherein the first skew value is adjusted to different values and the step of determining the second skew value according to the first clock signal and the first data signal comprises:
under the first skew values with different values, determining whether the received first data signal is correct respectively, so as to select one or more appropriate skew values from the candidate skew values; and
selecting the respective second skew value from the one or more appropriate skew values.

35. The skew adjustment method of claim 34, further comprising:
before receiving the first clock signal and the first data signal, generating the first clock signal and the first data signal, wherein there is an initial skew value between the first clock signal and the first data signal; and
adjusting the initial skew value to the different values.
